(19) United States
(12) Patent Application Publication
(10) Pub. No.: US 2023/0032188 A1
(43) Pub. Date: Feb. 2, 2023

(54) HOLDER FOR FIXING AN ELECTRIC COMPRESSOR

(71) Applicant: Vibracoustic SE, Darmstadt (DE)

(72) Inventors: Erik Myklebust, Kongsberg (NO); Niklas Müller, Ihringen (DE)

(21) Appl. No.: 17/876,111

(22) Filed: Jul. 28, 2022

(30) Foreign Application Priority Data
Jul. 29, 2021 (DE) 102021119801.1

(51) Int. Cl. F04B 39/14; F04B 39/00; F04B 39/12; F04B 35/04

(52) U.S. Cl. CPC F04B 39/14; F04B 35/04; F04B 39/0044; F04B 39/121

(57) ABSTRACT

The invention relates to a holder suitable for fixing an electrical compressor in a vehicle. In embodiments the holder comprises a housing with a receptacle, the housing configured to accommodate the electrical compressor in the receptacle. The housing may have a connector for fixing the electrical compressor on a mounting of a vehicle, and the holder may comprise at least one damper.

### CROSS-REFERENCE TO RELATED APPLICATIONS

This application claims priority to German Patent Application No. DE 10 2021 119 801.1, filed Jul. 29, 2021, the contents of which are hereby incorporated by reference in its entirety.

### TECHNICAL FIELD

The invention relates to holders for fixing an electrical compressor, including holders for fixing an electrical compressor in vehicles.

### BACKGROUND

In many modem vehicles, such as for example hybrid and electric automobiles, the air-conditioning systems installed there provide not only for the cooling of the interior compartment but also for the cooling of the battery. Said air-conditioning systems are in turn dependent on electrical compressors, which suck in air or refrigerant, compress it and subsequently discharge it again. Such compressors are commonly installed in the front vehicle region. Here, said compressors are fastened, normally by means of force-fitting connection, either directly on the internal combustion engine or on the electric drive unit (EDU), or they are mounted on a mounting or supporting structure that is provided for this purpose and is connected to the chassis. Here, within the context of this disclosure, all the supporting structures of the vehicle are referred to as a mounting, unless the respectively specific context suggests otherwise. Thus, a mounting is to be understood as meaning any structure which makes possible force-fitting fastening of a compressor on the chassis of the vehicle, that is to say for example a mounting bar installed in the engine compartment or the engine itself.

In the active state, electrical compressors generate vibrations or oscillations that are emitted especially in an axial direction and also in a radial direction extending perpendicularly to the longitudinal axis of the compressor. Said vibrations can be transmitted into other regions of the vehicle, for example into the passenger compartment, via the force-fitting connection of the compressor to the vehicle chassis. There, the vibrations and oscillations can be perceived, and deemed disturbing, by the driver. Beside the oscillations, the compressors, in the operating state, can also attain a noise level which leads to increased loudness of the vehicle as a whole, in particular of the interior of the passenger compartment. The same applies analogously to other motor-vehicle parts whose natural vibrations and loudness can lead to the comfort in the passenger compartment being disturbed.

In the prior art, as a solution, provision may be made for example for the compressor to be at least partially accommodated in a housing which is intended to serve as sound protection. In this case, the common housings normally have a hard outer shell which has on its inner side -that is to say on its side facing toward the compressor - a sound-absorbing material.

However, a disadvantage of such housings is that they are not able to sufficiently prevent a transmission of the vibrations of the electrical compressor to the chassis, and thus also into the passenger compartment, because they provide only acoustic protection.

### SUMMARY

It is therefore a desire of the present invention to provide a holder which overcomes problems or challenges of the prior art and/or which, beside absorption of the acoustic energy, makes possible in particular absorption of the oscillations or vibrations of an electrical compressor installed in a vehicle or of a comparable component.

Various aspects and features of the invention are disclosed herein.

According to embodiments of the invention, overcoming problems of the prior art may be achieved by a holder for fixing an electrical compressor in a vehicle, wherein the holder comprises a housing with a receptacle, and wherein the housing is configured to accommodate the electrical compressor in the receptacle. The housing according to embodiments may have a connector for fixing or for mounting the electrical compressor on a mounting of a vehicle. Further, the holder may comprise a damper (which may comprise various damping mechanisms).

With a holder configured as disclosed herein, it may be possible for an electrical compressor (or a comparable component) to be accommodated, and to be held, supported or fixed, in such a way that an otherwise necessary direct force-fitting connection of the compressor to the vehicle - for example via screw connections, clamping connections or rivet connections - can be dispensed with. This makes it possible for transmission of vibrations generated by the electrical compressor directly to the chassis of a vehicle to be prevented, as the direct force path between compressor and mounting required for that to occur is absent. For the compressor to be fastened in an automobile, the housing has a connector for the fixing thereof on a mounting of a vehicle. Consequently, the electrical compressor is not, as is normally the case, connected directly to the chassis, the engine, or a comparable supporting structure of a vehicle, and subsequently, for the purpose of sound absorption, surrounded by a housing. Instead, the compressor is supported or held completely by the holder and is connected (as it were indirectly) to other structures of the vehicle only through the fastening of the holder on the mounting via the connector.

At the same time, the at least one damper of the holder can provide absorption of vibration and/or of sound. The holder may include, for example, a first damper and a second damper, wherein the first damper absorbs sound, and wherein the second damper counteracts in particular a transmission of vibrations of the compressor to the chassis. It may thus be provided, for example, that the first damper comprises a sound-absorbing lining of the receptacle of the housing, and that the second damper comprises one or more dampers (or damping means) which are arranged between the housing and the mounting of the vehicle frame and thus prevent the transmission of the natural vibrations of the compressor to the chassis.

The connector for fixing or mounting the holder on the provided mounting of the vehicle may comprise a clamp (or clamping mechanism), a rivet (or rivet mechanism), or a screw (or screw mechanism). It is also conceivable for the connector to comprise a bore or a cutout in the housing of the holder, which can be brought into alignment with a further bore or opening in the mounting, wherein the holder can subsequently be fixed on the suspension by means of a bolt or a screw.

Consequently, a holder according to embodiments of the invention can address not only sound absorption but also absorption of the vibrations or oscillations of the compressor. As a result, driving comfort may be increased.

It may moreover be provided that the damper is configured for acoustic damping of the electrical compressor and/or for damping the vibration of the electrical compressor and/or for damping the force path of the electrical compressor to the mounting of the vehicle. In this way, it can be better ensured that both the noises of the compressor entering the passenger compartment and the vibrations of the compressor entering the passenger compartment are reduced, and may minimized. This can be advantageous in comparison with the known solutions because, although the compressor housings used there can be used as sound protection, they cannot be used as vibration protection since, there, it is at all times provided that the electrical compressor itself is connected in a force-fitting manner to the supporting structure of the vehicle.

It is furthermore conceivable for the damper to comprise at least one internal damper (or internal damping means) and/or at least one external damper (or external damping means). As such, it may be provided that the internal damper is arranged in the receptacle at least sectionally on an inner side of the housing, wherein the internal damper may comprise a lining of the inner side. A lining on the inner side of the housing may have the advantage that the holder can accommodate and hold the compressor in a sound- and vibration-absorbing manner. As such, the internal damper in the form of a lining of the receptacle may, for example, comprise a polyurethane (PU) foam applied fully or partially to the inner side of the housing. Instead of or in addition to a PU foam, it is also possible for a cushion or “pad” produced from an elastomer to be provided as an internal damper. Particularly the internal damper, but also the external damper, may be connected in a materially bonded manner, for example via a suitable adhesive, to the housing. Furthermore, it may be provided that the housing of the holder surrounds the compressor in a substantially form-fitting manner, so that the compressor has no or only very little “play” in the receptacle.

According to a refinement of the holder, a holder may be provided such that an external damper is arranged on an outer side of the receptacle of the housing, wherein, when the holder is being used as intended, the external damper is arranged between the housing and the mounting of the vehicle, wherein, when the holder is being used as intended, the external damper is arranged between the connector and the mounting of the vehicle. Here, use of the holder as intended may mean the state of the holder in which it is installed in a vehicle for the purpose of accommodating an electrical compressor. An external damper means may, for example, comprise an elastomer ring element or a comparable elastomer body. In this way, vibrations which are possibly, despite internal damping means, transmitted from the compressor to the housing may be additionally absorbed because the direct force path from the housing to the chassis is interrupted by the external damping means.

Furthermore, it may be provided that the damper comprises an absorbing material, wherein the absorbing material is sound-absorbing and/or force-absorbing and/or vibration-absorbing. It has moreover proven to be advantageous for the at least one absorbing material to be an elastomer, a textile material, a foam, or a mixture of the above-mentioned materials. According to a refinement of the holder according to the invention, it may moreover be provided that the elastomer is a rubber. It is conceivable that the textile material is a nonwoven. It is furthermore conceivable that the foam is a polyurethane foam (=PU foam). Moreover, it may be provided that the holder has at least one internal damper which is produced from a sound-absorbing material (for example, nonwoven or PU foam), and that, at the same time, the holder has at least one external damper which is produced from a vibration-absorbing material (for example, elastomer, such as specifically rubber).

According to an embodiment, it may moreover be provided that the housing is produced from a plastic. Here, the housing is produced in particular from a fiber-reinforced plastic in order to withstand the forces which, due to the accommodation and holding of the electrical compressor, act on the holder. At the same time, the housing, produced from a plastic material, has a low intrinsic weight.

It may be provided in particular that the holder is configured in such a way that the electrical compressor can be fixed on the mounting of the vehicle exclusively via the holder. This embodiment is preferred and has the advantage that a direct force path from the compressor to the mounting of the vehicle can be avoided. Instead, the holder according to the invention makes it possible for the compressor to be accommodated solely in the receptacle of the housing and to be held, or supported, there - an additional force-fitting connection of the compressor at the mounting, as has hitherto been conventional, no longer being necessary. In this way, the disturbing vibrations of the compressor can be decoupled from the passenger compartment, which results in the driving comfort being improved. The degree of decoupling of the vibration is increased in that the housing is connected to the mounting via an external damper.

Advantageously, it may be provided according to an embodiment that the housing at least partially surrounds or encapsulates the electrical compressor when the electrical compressor is accommodated in the receptacle of the housing. According to a refinement of the holder according to the invention, it may be provided that the housing surrounds the electrical compressor in such a way that the housing conceals substantially at least 60% of a surface of the electrical compressor when the electrical compressor is accommodated in the receptacle of the housing. In this way, the housing of the holder itself can act as a structural component that connects the electrical compressor to the vehicle in a stable and reliable manner. At the same time, the compressor being surrounded to the greatest possible extent by the housing ensures maximum sound absorption. Preferably, only a portion of the compressor remains “free”, that is to say not surrounded by the housing of the holder, on which portion connections to other mechanical or electrical vehicle parts (such as for example, entries/exits for cables, hoses or the like) are arranged.

It is furthermore conceivable for the housing to comprise at least two housing segments. Ideally, it is provided that the housing comprises exactly least two housing segments. In this way, it is possible to achieve as great an encapsulation of the electrical compressor as possible with as few components as possible. Thus, in particular, a refinement may be provided in which the housing comprises a first housing segment and a second housing segment, wherein the first housing segment and the second housing segment are connected to one another in such a way that they form the receptacle of the housing. It is conceivable for example for the two housing segments to be pivotably or foldably connected to one another at a section. In this way, the housing can be arranged particularly easily on the compressor. A subsequent complete connection of the housing segments may be realized for example in a materially bonded manner, by way of an adhesive, or in a force-fitting manner, via a clamping mechanism or screw mechanism.

Further features, details and advantages of the invention emerge from the wording of the claims and from the following description of exemplary embodiments on the basis of the drawings. In the drawings:

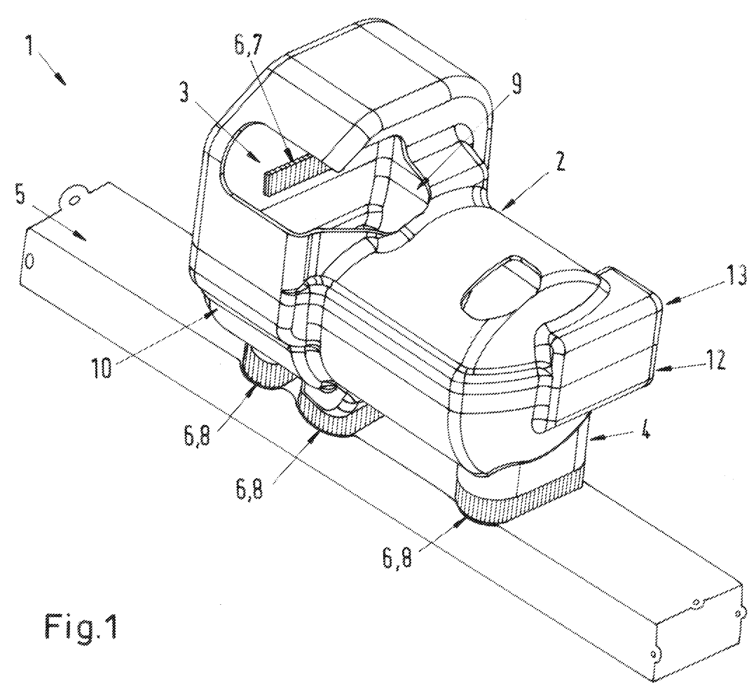

FIG. 1 shows a perspective view of a holder according to an embodiment which is being used as intended.

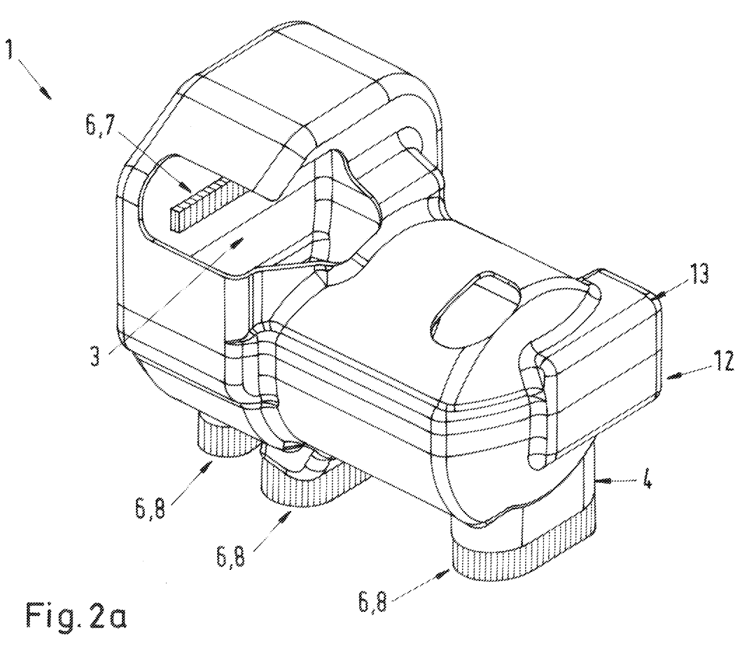

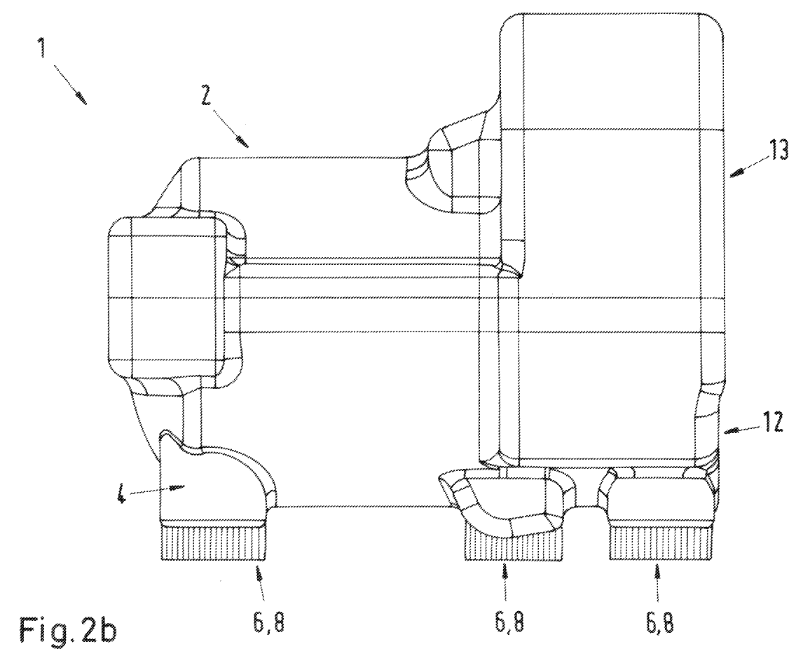

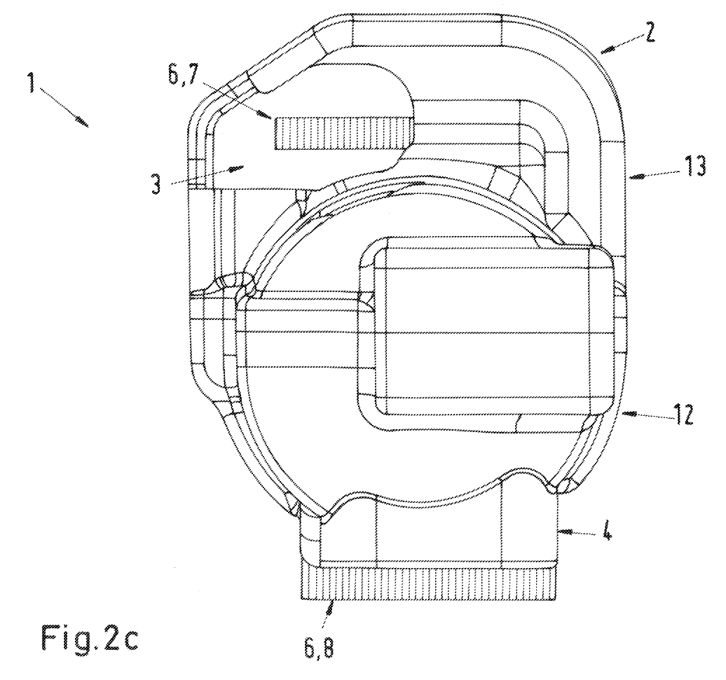

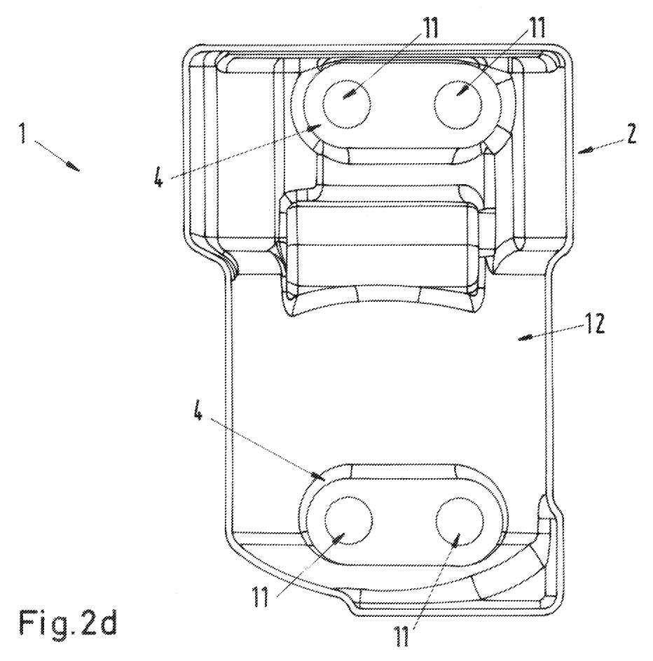

FIG. 2a shows a perspective view of a holder according to an embodiment.

FIG. 2b shows a side view of the holder as per FIG. 2a.

FIG. 2c shows a front view of the holder as per FIG. 2a.

FIG. 2d shows a view of the bottom side of the holder as per FIG. 2a.

FIG. 2e shows a view of the top side of the holder as per FIG. 2a.

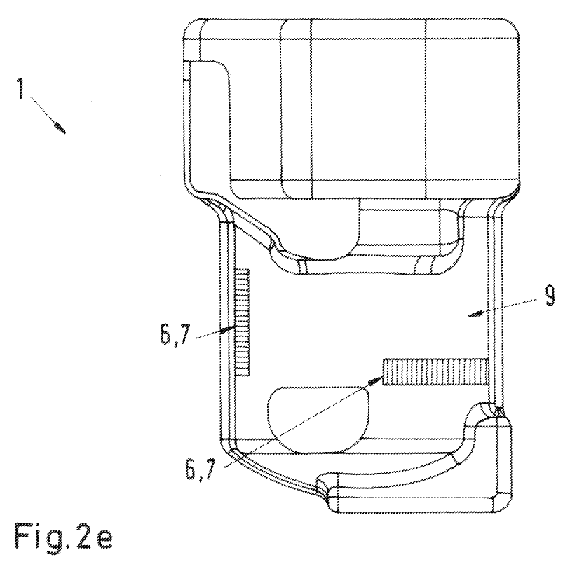

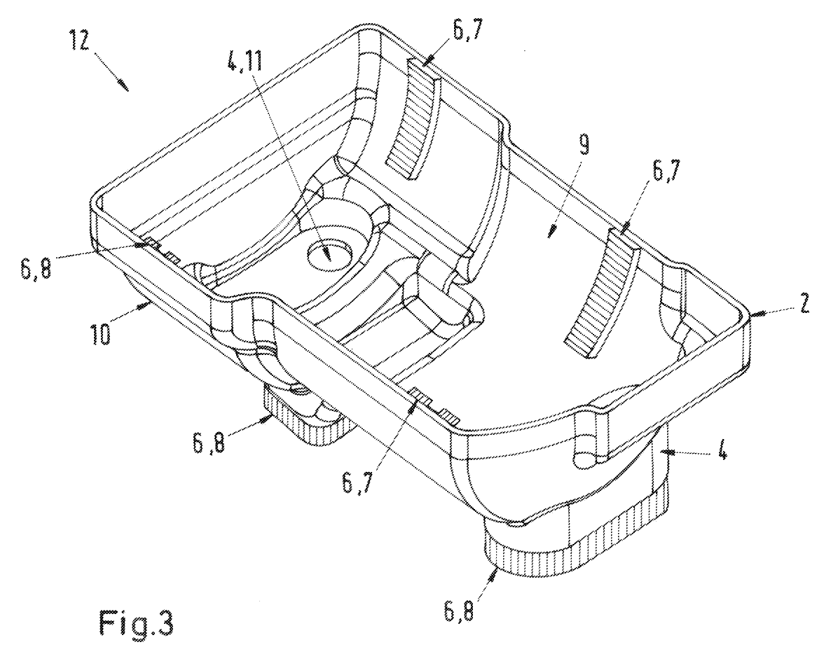

FIG. 3 shows a perspective view of a first housing segment of a holder according to an embodiment.

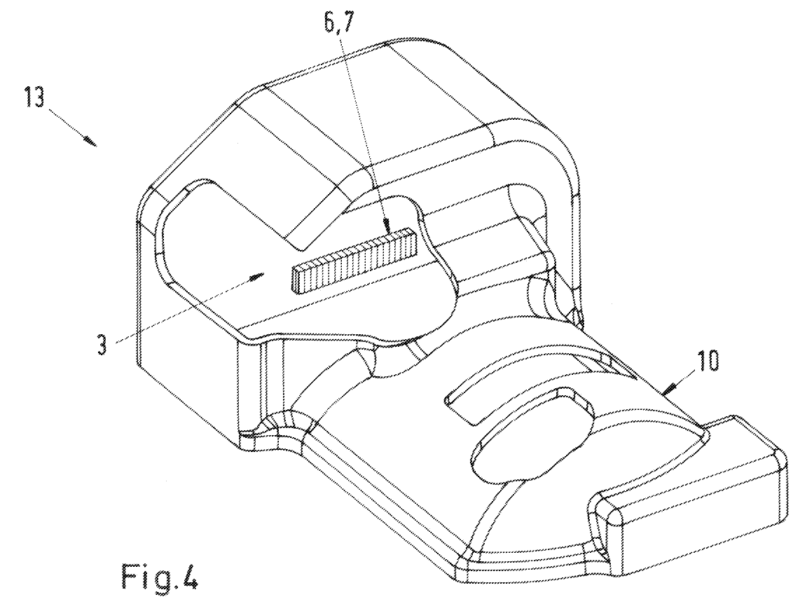

FIG. 4 shows a perspective view of a second housing segment of a holder according to an embodiment.

In the figures, identical or mutually corresponding elements are denoted in each case by the same reference signs and will therefore not be described again unless expedient. In order to avoid repetitions, features that have already been described will not be described again, and such features are applicable to all elements with the same or mutually corresponding reference signs unless this is explicitly ruled out. The disclosures in the description as a whole are transferable analogously to identical parts with the same reference signs or the same component designations. It is also the case that the positional indications used in the description, such as for example above/top, below/bottom, lateral, etc., relate to the figure presently being described and illustrated and, in the case of the position being changed, are to be transferred analogously to the new position. Furthermore, it is also possible for individual features or combinations of features from the different exemplary embodiments shown and described to constitute independent or inventive solutions or solutions according to the invention.

FIG. 1 shows in a perspective view a holder 1 according to an embodiment, wherein the holder 1 as per FIG. 1 is being used as intended, that is to say the holder 1 is installed in a vehicle for the purpose of accommodating an electrical compressor. For the fastening of the holder 1 in the vehicle, the holder 1 may be fixed or fastened on a mounting 5. As shown by way of example in FIG. 1, the mounting may be a mounting bar, said mounting bar being installed in the engine compartment of the vehicle. A fixing of the holder 1 directly on the engine or on the electric drive unit (EDU) of the vehicle is also conceivable, however.

The holder 1 shown in FIGS. 2a-e differs from the holder 1 as per FIG. 1 only in that the holder 1 in FIGS. 2a-e is not fastened on a mounting 5.

The holder from FIG. 1 and FIGS. 2a-e comprises a housing 2 with a receptacle 3. The housing 2 is configured to accommodate an electrical compressor or a comparable vehicle part in the receptacle 3 formed by the housing 2. At the same time, the housing 2 has a connector for fixing or mounting the holder 1 on the mounting 5 of the vehicle. The connector 4 may in this case comprise a screw system or bolt system that comprises cutouts in the housing 2 of the holder 1 as well as screws or bolts, wherein the screws or bolts can be guided through the cutouts 11 of the housing 2 of the holder 1 and screwed or inserted into corresponding openings in the mounting 5. The connector 4 thereby ensures that the holder 2 can, in a stable, secure and reliable manner, be fixed on the mounting 5 and thus be installed in the vehicle. In this way, the electrical compressor is not, as is normally the case, connected directly to the chassis or the engine of the vehicle and subsequently, for the purpose of sound absorption, surrounded by a housing 2, but rather it is accommodated or held completely by the holder 1 and is thus in a state indirectly connected to the other structures of the vehicle only through the fastening of the holder 1 on the mounting 5 via the connector 4 of the holder 1.

So if the electrical compressor is now held by the holder 1, then the compressor, for its part, is in a state securely installed in the vehicle. Here, a direct transmission of oscillations or vibrations from the compressor to the basic structure of the vehicle is avoided because no direct force path between compressor and mounting 5 of the vehicle is established.

To additionally minimize the extent of the transmission of vibrations from the compressor to the supporting structures of the vehicle, the holder 1 may comprise a damper 6. As shown in FIG. 1 and FIGS. 2a-e, said damper 6 may comprise different dampers (or damping means) 7, 8. The damper 6 of the holder 1 provides for absorption of vibration in a simple manner. In addition, the holder 1 shown is also suitable for absorption of sound, that is to say of noises emitted by the compressor in the operating state. For this purpose, the holder 1 may have for example a first damper (or damping means) 7 and a second damper (or damping means) 8, wherein the first damper 7 absorbs sound, and wherein the second damper 8 counteracts in particular a transmission of vibrations of the compressor to the chassis in a damping manner. Unlike what is shown in FIG. 1 and FIGS. 2a-e, the first damper 7 may for example also comprise a full sound-absorbing lining of the inner side 9 of the receptacle 3 of the housing 2, wherein the lining may comprise a PU foam.

As shown in FIG. 1 and FIGS. 2a-e, the first damper 7 is an internal damper 7.

As illustrated in the figures, the internal damper means 7 may be arranged in the receptacle 3 at least sectionally on an inner side 9 of the housing 2, wherein in the present case the internal damper 7 may be in the form of a cushion or “pad” comprising an elastomer material. The internal damper 7 may be attached in a materially bonded manner, for example via an adhesive, to the inner side 9 of the housing 2. The external damper 8 may be arranged on an outer side 10 of the receptacle 3 of the housing 2. Here, when the holder 1 is being used as intended, the external damper 8 may be arranged between the housing 2 and the mounting 5 of the vehicle, wherein the external damper 8 may be specifically arranged between the connector 4 and the mounting 5 of the vehicle. The external damper 8 shown may comprise an elastomer. In this way, vibrations which are possibly, despite internal damping means, transmitted from the compressor to the housing may be additionally absorbed because the direct force path from the housing to the chassis is interrupted by the external damper.

A combination of various internal or external dampers 7, 8 is conceivable. In this case, the internal damper 7 may serve, for example, for acoustic damping of the electrical compressor, while the external damper 8 may be configured for damping the vibration of the electrical compressor and/or for interrupting the force path of the electrical compressor to the mounting of the vehicle. In this way, it can be better ensured that both the noises of the compressor entering the passenger compartment and the vibrations of the compressor entering the passenger compartment are reduced or minimized.

The damper 7, 8 used can comprise at least one absorbing material. Absorbing materials may be sound-absorbing and/or force-absorbing and/or vibration-absorbing. Exemplary materials are elastomers, such as for example rubber, textile materials, such as for example nonwovens, foams, such as for example PU foam, or a mixture of the above-mentioned materials. In embodiments, such as generally illustrated in FIG. 1 and FIGS. 2a-e, an internal damper 7 may be in the form of absorbing pads and an external damper 8 may be produced from rubber.

The holder 1 may comprise a housing 2 composed of plastic. With such, the housing 2 may be produced from a fiber-reinforced plastic in order to withstand forces which, due to the accommodation and holding of the electrical compressor, can act on the holder 1. At the same time, a housing 2, produced from a plastic material, may have a low intrinsic weight.

As shown in FIG. 1, the housing 2 may form an almost complete encapsulation for the electrical compressor when the electrical compressor is accommodated in the receptacle 3 of the housing 2. Consequently, the compressor may be shielded substantially in all three spatial directions, which can result in sound waves formed during the operation of the compressor being able to be absorbed efficiently by the housing 2 by way of the damper 6. As such, it is may be provided that the housing 2 surrounds the electrical compressor in such a way that it conceals substantially over 80% of the surface of the electrical compressor when the electrical compressor is accommodated in the receptacle 3 of the housing 2. According to the example shown in FIG. 1, it is provided that only a small portion of the compressor remains “free”, that is to say is not surrounded by the housing 2 of the holder 1. Said portion may be required for example for connections to other mechanical or electrical vehicle parts (such as for example, entries/exits for cables, hoses, or the like).

It is moreover advantageous for the housing 2 to bear as tightly as possible against the surface of the compressor, that is to say for the compressor to be arranged in a force- and/or form-fitting manner in the receptacle 3 of the holder. In this way, the housing 2 of the holder 1 itself can act as a supporting component that connects the electrical compressor to the vehicle in a stable and reliable manner.

As shown in FIG. 3 and FIG. 4, the housing 2 may comprise at least two housing segments 12, 13. Here, it is provided in particular that the housing 2 comprises exactly two housing segments 12, 13, specifically a first housing segment 12 and a second housing segment 13. Such a configuration may make it possible to achieve the greatest possible encapsulation of the electrical compressor with only few components. The first housing segment 12 and the second housing segment 13 may be connected to one another in such a way that they form the receptacle of the housing 2. The two housing segments 12, 13 may be connected in a force- or form-fitting manner and thus stably fix the compressor in the receptacle 3 when the compressor is accommodated in the holder 1.

The invention is not restricted to one of the embodiments described above, but rather may be modified in a variety of ways.

All the features and advantages that emerge from the claims, from the description and from the drawing, including structural details, spatial arrangements and method steps, may be essential to the invention both individually and in a wide variety of combinations.

To avoid repetitions, it is the intention that features disclosed in device terms are also disclosed, and capable of being claimed, in method terms. It is likewise the intention that features disclosed in method terms are disclosed, and capable of being claimed, in device terms.

1. A holder for fixing an electrical compressor in a vehicle, comprising:
a housing with a receptacle,
wherein the housing is configured to accommodate said electrical compressor in the receptacle, the housing has a connector for fixing said electrical compressor on a mounting of said vehicle, and the holder including at least one damper.

2. The holder as claimed in claim 1, wherein the damper is configured for acoustic damping of said electrical compressor and/or for damping the vibration of said electrical compressor and/or for damping a force path of said electrical compressor to the mounting of said vehicle.

3. The holder as claimed in claim 1, wherein the damper comprises at least one internal damper and/or at least one external damper.

4. The holder as claimed in claim 1, wherein at least one internal damper is arranged in the receptacle at least sectionally on an inner side of the housing, and the internal damper comprises a lining of the inner side.

5. The holder as claimed in claim 1, wherein an external damper is arranged on an outer side of the receptacle of the housing; when the holder is used as intended, the external damper is arranged between the housing and the mounting of said vehicle; and, when the holder is used as intended, the external damper is arranged between the connector and the mounting of said vehicle.

6. The holder as claimed in claim 1, wherein the damper comprises an absorbing material, and wherein the absorbing material is sound-absorbing and/or force-absorbing and/or vibrationabsorbing.

7. The holder as claimed in claim 6, wherein the absorbing material is an elastomer, a textile material, a foam, or a mixture of one or more of the foregoing materials.

8. The holder as claimed in claim 7, wherein the elastomer comprises rubber.

9. The holder as claimed in claim 7, wherein the textile material is a nonwoven.

10. The holder as claimed in claim 7, wherein the foam is a polyurethane foam.

11. The holder as claimed in claim 1, wherein the housing is produced from a plastic.

12. The holder as claimed in claim 1, wherein the holder is configured such that the electrical compressor can be fixed on the mounting of said vehicle exclusively via the holder.

13. The holder as claimed in claim 1, wherein the housing at least partially surrounds the electrical compressor when the electrical compressor is accommodated in the receptacle of the housing.

14. The holder as claimed in claim 1, wherein the housing surrounds the electrical compressor such that the housing conceals substantially at least 60% of a surface of the electrical compressor when the electrical compressor is accommodated in the receptacle of the housing.

15. The holder as claimed in claim 1, wherein the housing comprises at least two housing segments.

16. The holder as claimed in claim 1, wherein the housing comprises a first housing segment and a second housing segment, and the first housing segment and the second housing segment are connected to one another to form the receptacle of the housing.
